(19) United States
(12) Patent Application Publication
(10) Pub. No.: US 2015/0111632 A1
(43) Pub. Date: Apr. 23, 2015

(54) Electronic Gaming Machine and Gaming Method

(71) Applicant: AINSWORTH GAME TECHNOLOGY LIMITED, Newington (AU)

(72) Inventor: Jason Meyer, Abbotsford (AU)

(21) Appl. No.: 14/493,300

(22) Filed: Sep. 22, 2014

(30) Foreign Application Priority Data
Oct. 18, 2013 (AU) 2013245553

(51) Int. Cl. G07F 17/34; G07F 17/32

(52) U.S. Cl. CPC G07F 17/34; G07F 17/3213
USPC 463/20

(57) ABSTRACT

An electronic gaming machine includes a housing having a display for displaying a game, an electronic game controller and an input means in electronic communication with said electronic game controller for receiving commands from a player to operate said electronic gaming machine. The game comprises predetermined winning combinations of randomly selected game symbols that award prizes to a player and a plurality of bet levels for the game, the bet levels comprising at least a default bet level. The electronic game controller enables selection of one of the bet levels via said input means and in response to a selected bet level different to the default bet level, the electronic game controller changes a bonus prize associated with the game. A gaming method is also provided.

### BACKGROUND

The invention relates to an electronic gaming machine and in a particular an electronic gaming machine employing a jackpot prize associated with a game played on the electronic gaming machine. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may be provided by an electronic gaming machine in addition to the base or main game. Typically feature games use the same set of reels as the main game and are limited to a set of free games operated under a single set of rules. Once the free feature games have been played, the electronic gaming machine resets itself and returns the player back to the base game.

Also, electronic gaming machines can offer one or more bonus prizes to the player during play of the game. The most common type of bonus prize that is awarded by the electronic gaming machine is a jackpot prize, the main example of which is a progressive jackpot prize. A progressive jackpot prize takes a portion of each bet (typically a set percentage of each bet) made on the electronic gaming machine and thus the amount of the progressive jackpot inclemently increases as more bets are made on the electronic gaming machine. The progressive jackpot is typically awarded when a winning game combination associated with the jackpot occurs in the game played on the electronic gaming machine. In many cases, progressive jackpots are associated with the least probable winning combination and are commonly the highest paying award of the electronic gaming machine. Alternatively, or additionally, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some electronic gaming machines, more than one jackpot or progressive jackpot is offered by the electronic gaming machine or electronic gaming machines linked together.

This standard structure to game play and bonus prizes limits the variation in the play of the electronic gaming machine. Consequently, it is difficult to retain player interest because there is no apparent incentive for the player to continue playing the same electronic gaming machine once the player becomes familiar with the feature game and the main game. Also, it is difficult to retain player interest since there is little differentiation between gaming machines in terms of the main and feature games that are played.

It is an object of the invention to overcome or substantially ameliorate one or more of the disadvantages of prior art, or at least to provide a useful alternative.

It is an object of the invention in at least one preferred form to provide an electronic gaming machine and a method for controlling an electronic gaming machine that encourages player interest.

### SUMMARY

According to a first aspect of the invention, there is provided an electronic gaming machine comprising:

a display for displaying a game, and

an electronic game controller for controlling the display of said game on said display,

wherein said game comprises predetermined winning combinations of randomly selected game symbols that award prizes to a player and a plurality of bet levels for said game, said bet levels comprising at least a default bet level,

wherein said electronic game controller enables selection of one of said bet levels, and

in response to a selected bet level different to said default bet level, said electronic game controller changes a bonus prize associated with said game.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

A second aspect of the present invention provides an electronic gaming machine comprising:

a housing having a display for displaying a game and an electronic game controller for controlling the display of game symbols on said display, wherein said game comprises game symbols arranged into an array of symbol positions and predetermined winning combinations of randomly selected game symbols that award prizes to a player, wherein there is a plurality of bet levels for said game, said bet levels comprising at least a default bet level; and

an input means for receiving commands from said player to operate said electronic gaming machine and initiate play of said game on said display, said input means being in electronic communication with said electronic game controller;

wherein said electronic game controller in response to a command from said player via said input means commences play of said game by randomly selecting game symbols and transmitting a signal to said display to display said randomly selected game symbols in said symbol positions on said array;

wherein said electronic game controller enables selection of one of said bet levels by said player via said input means; and

in response to a selected bet level different to said default bet level, said electronic game controller changes a bonus prize associated with said game.

Preferably, said electronic game controller transmits a signal to said display to indicate said bonus prize change on said display. More preferably, said bonus prize change is visually displayed on said display. In some embodiments, said bonus prize change is indicated on said display by one or more of animating a bonus prize image associated with said bonus prize on said display, highlighting said bonus prize image on said display, changing said bonus prize image on said display, displaying one or more animated images on said display, visually linking said bonus prize change to said selected bet level on said display and playing one or more aural sounds.

Preferably, said bonus prize change comprises changing the value of said bonus prize in response to said selected bet level.

Preferably, said bonus prize changes in value based on a numerical value associated with said selected bet level. In one preferred form, said numerical value is the ratio of said selected bet level to said default bet level and the value of said bonus prize changes by said ratio. In another preferred form, said numerical value is a base prize bonus value and the value of said bonus prize changes by said base prize bonus value multiplied by the number of bet levels between said selected bet level and said default bet level. In a further preferred form, said bet levels are respectively associated with different bonus prize values and said bonus prize changes to the bonus prize value associated with said selected bet level.

Preferably, a portion of said bonus prize changes in value and the remainder of said bonus prize does not change. More preferably, said bonus prize portion changes in value based on a numerical value associated with said selected bet level. In one preferred form, said numerical value is the ratio of said selected bet level to said default bet level and the value of said bonus prize portion changes by said ratio. In another preferred form, said numerical value is a base prize bonus value and the value of said bonus prize portion changes by said base prize bonus value multiplied by the number of bet levels between said selected bet level and said default bet level. In a further preferred form, said bet levels are respectively associated with different bonus prize portion values and said bonus prize portion changes to the bonus prize portion value associated with said selected bet level.

Preferably, said selected bet level is selected by said player during play of said game. Alternatively, or additionally, said selected bet level is selected by said player prior to playing said game.

Preferably, said bonus prize has an initial bonus prize value associated with said default bet level.

Preferably, said default bet level is the bet level that is currently selected to play said game. Alternatively, said default bet level is the bet level previously selected on said electronic gaming machine. In a further alternative, it is preferred that said default bet level is one of said bet levels initially selected by said electronic game controller. In one preferred form, said electronic game controller selects the bet level with the lowest value of said bet levels as said default bet level.

Preferably, said bet levels comprise bet denominations for said game. More preferably, each change in said bet denomination causes said bonus prize change. In one preferred form, said numerical value comprises the ratio of said selected bet denomination to said default bet denomination.

Alternatively, it is preferred that said game comprises said randomly selected game symbols displayed in an array of predetermined game positions, and said bet levels are associated with one or more combinations of said predetermined game positions. In one preferred form, said bet levels comprise bet amounts for each said combination.

Preferably, said electronic gaming machine provides a plurality of said games, said games being linked to said bonus prize. Alternatively, said electronic gaming machine provides a plurality of said games and a plurality of said bonus prizes, and at least one of said bonus prizes is shared by two or more of said games. More preferably, all of said bonus prizes are shared by two or more of said games.

Preferably, said bonus prize is one of a jackpot prize, a progressive jackpot prize or a mystery bonus prize.

Preferably, said electronic gaming machine comprises one or more additional bonus prizes that do not change in response to said selected bet level. More preferably, said electronic gaming machine comprises said additional bonus prizes and said bonus prize.

Preferably, there is a plurality of said bonus prizes. More preferably, said electronic gaming machine comprises said bonus prizes and additional bonus prizes that do not change in response to said selected bet level.

Preferably, said numerical value associated with said selected bet level is indicated on said display. More preferably, said numerical value is indicated during play of said game.

Preferably, said bonus prize is awarded upon the occurrence of a trigger event. More preferably, said trigger event comprises the appearance of a predetermined bonus prize winning combination of said randomly selected game symbols in said game. In one preferred form, said bonus prize winning combination comprises one or more special symbols. In a particularly preferred form, said bonus prize winning combination comprises the appearance of three special symbols.

Preferably, said electronic game controller randomly determines the appearance of said special symbols in said game.

Alternatively, said trigger event comprises said electronic game controller randomly generating a number and determining whether said randomly generated number is a predetermined number or within a predetermined range of numbers.

Preferably, said special symbol may also act as another type of game symbol. More preferably, said special symbol may also act as at least one of a replacement symbol, a wild card symbol, a scatter symbol, bonus prizes, collector symbols, a win multiplier, wild multipliers, bonus wilds, random wild symbols, progressive symbols, bonus credits and jackpot symbols. In one preferred form, said special symbol acts as a wild card symbol.

Preferably, said array of predetermined game positions comprises rows and columns. In one preferred form, said columns comprise a spinnable reel of predetermined game positions. In another preferred form, each said predetermined game position comprises an individual spinnable reel.

Preferably, said game comprises a base game and a feature game, wherein said one or more special symbols appear in said feature game. Alternatively, said one or more special symbols appear in said base game.

Preferably, the same game symbols are used in said feature game and said base game. Alternatively, different game symbols or a mixture of the same and different game symbols are used in said feature game and said base game.

Preferably, said feature game has the same number of game symbols as said base game. Alternatively, said feature game and said base game have different numbers of game symbols.

Preferably, the game symbols in said feature game and said base game are organised or arranged in the same way. In another preferred form, the game symbols in said feature game and said base game are organised or arranged differently to each other.

Preferably, said game symbols in said feature game and said base game are arranged in arrays of the same shape or type. Alternatively, said game symbols in said feature game and said base game are arranged in differently shaped arrays. The shapes of said arrays are preferably rectangular, circular, triangular, oval, semi-circular or other non-rectangular shape.

Preferably, said electronic game controller causes the display of said feature game in response to a feature game trigger event. Alternatively, said electronic game controller causes the display of said feature game and said base game during play of said base game, said feature game being inactive until triggered. In this preferred form, the change in said feature game from being inactive to active may be indicated on the display.

Preferably, said electronic game controller causes the display of said base game on a separate display to said display. Alternatively, said electronic game controller causes the display of said feature game and said base game on the same display.

Preferably, said input means comprises one or more buttons on said housing, said buttons being in electronic communication with said electronic game controller to transmit player commands to said electronic game controller. More preferably, said buttons are arranged on a console of said housing. Alternatively or additionally, said input means comprises a touch sensitive surface on said display for receiving player commands, said touch sensitive surface being in electronic communication with said electronic game controller to transmit player commands to said electronic game controller.

Preferably, said housing comprises a value transfer mechanism for paying said prizes to said player using value in an amount equal to an awarded prize. More preferably, said value transfer mechanism also receives value from said player to initiate said bet. In one embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Preferably, the electronic gaming machine comprises a mobile electronic gaming device. More preferably, said mobile electronic gaming device comprises a handheld electronic device. Alternatively, said electronic gaming machine comprises a computer. More preferably, said computer is connected to a communication network.

A third aspect of the invention provides a gaming system comprising a plurality of electronic gaming machines of the first or second aspect of the invention, wherein said electronic gaming machines are in electronic communication with each other and said bonus prize is associated with at least one game of each said electronic gaming machine.

Preferably, said gaming system comprises a central game controller for controlling said plurality of electronic gaming machines, said central game controller being located in a remote server. Alternatively, said plurality of electronic gaming machines are in direct electronic communication with each other.

Preferably, said plurality of electronic gaming machines are in wireless electronic communication with each other. Alternatively, said plurality of electronic gaming machines are in wired electronic communication with each other.

Preferably, said bonus prize is associated with two or more of said games on each said electronic gaming machine. In one preferred form, said bonus prize is associated with all of said games on each said electronic gaming machine.

Preferably, there is a plurality of said bonus prizes on each said electronic gaming machine. More preferably, one or more of said bonus prizes are shared by two or more of said games on each said electronic gaming machine.

Preferably, said system further comprises a bonus prize controller in electronic communication with said electronic game controllers of said electronic gaming machines for controlling the display of said bonus prize.

The gaming system preferably has the preferred features of the first or second aspect of the invention stated above, where applicable.

According to a fourth aspect of the invention, there is provided a gaming method for an electronic gaming machine comprising a display and an electronic game controller, the method comprising:

controllably displaying game symbols for playing a game, wherein said game comprises predetermined winning combinations of randomly selected game symbols that award prizes to a player and a plurality of bet levels for said game, said bet levels comprising at least a default bet level;

enabling selection of one of said bet levels, and

in response to said selection of a selected bet level different to said default bet level, changing a bonus prize associated with said game.

A fifth aspect of the present invention provides an electronic gaming method for an electronic gaming machine comprising a housing having a display for displaying a game and an electronic game controller for controlling the display of game symbols on said display; wherein said game comprises game symbols displayed in an array of symbol positions and predetermined winning combinations of game symbols in said game award prizes to a player, wherein there is a plurality of bet levels for said game, said bet levels comprising at least a default bet level; and an input means for receiving commands from said player to operate said electronic gaming machine and initiate play of said game on said display, said input means being in electronic communication with said electronic game controller, the method comprising:

said electronic game controller receiving a command from said player via said input means;

said electronic game controller commencing a play of said game by randomly selecting game symbols and transmitting a signal to said display to display said randomly selected game symbols in said symbol positions on said array;

said electronic game controller enabling said player to make a selection of one of said bet levels via said input means; and

in response to said selection of a selected bet level different to said default bet level, said electronic game controller changing a bonus prize associated with said game.

Preferably, said method further comprises said electronic game controller transmitting a signal to said display to indicate said bonus prize change on said display. More preferably, said indicating step comprises said display visually displaying said bonus prize change on said display. In some embodiments, said indicating step comprises one or more of animating a bonus prize image associated with said bonus prize on said display, highlighting said bonus prize image on said display, changing said bonus prize image on said display, displaying one or more animated images on said display, visually linking said bonus prize change to said selected bet level on said display and playing one or more aural sounds.

Preferably, said bonus prize changing step comprises changing the value of said bonus prize. More preferably, wherein said bonus prize changing step comprises changing the value of said bonus prize based on a numerical value associated with said selected bet level. In one preferred form, said bonus prize changing step comprises changing the value of said bonus prize by the ratio of said selected bet level to said default bet level. In another preferred form, said numerical value is a base prize bonus value and said bonus prize changing step comprises changing the value of said bonus prize by said base prize bonus value multiplied by the number of bet levels between said selected bet level and said default bet level. In a further preferred form, said bet levels are respectively associated with different bonus prize values and said bonus prize changing step comprises changing to the bonus prize value associated with said selected bet level.

Preferably, said bonus prize changing step comprises changing the value of a portion of said bonus prize and not changing the value of the remainder of said bonus prize. More preferably, said bonus prize changing step comprises changing the value of said bonus prize portion based on a numerical value associated with said selected bet level. In one preferred form, said bonus prize changing step comprises changing the value of said bonus prize portion by the ratio of said selected bet level to said default bet level. In another preferred form, said numerical value is a base prize bonus value and said bonus prize changing step comprises changing the value of said bonus prize portion by said base prize bonus value multiplied by the number of bet levels between said selected bet level and said default bet level. In a further preferred form, said bet levels are respectively associated with different bonus prize portion values and said bonus prize changing step comprises changing said bonus prize portion to the bonus prize value associated with said selected bet level value.

Preferably, said selection enabling step comprises enabling said player to select said selected bet level during play of said game. Alternatively or additionally, it is preferred that said selection enabling step comprises enabling said player to select said selected bet level prior to playing said game.

Preferably, said bonus prize has an initial bonus prize value, said method further comprising associating said initial bonus prize value with said default bet level.

Preferably, said default bet level is the bet level previously selected on said electronic gaming machine as said default bet level. Alternatively, said default bet level is the bet level that is currently selected to play said game.

Preferably, said method further comprises said electronic game controller initially selecting one of said bet levels as said default bet level. More preferably, said electronic game controller selects the bet level with the lowest value of said bet levels as said default bet level.

The methods of the fourth and sixth aspects preferably have the preferred features of the first or second aspects of the invention stated above, where applicable.

A sixth aspect of the invention provides a gaming method for operating a plurality of electronic gaming machines in electronic communication with each other, comprising the gaming method of the fourth or fifth aspect of the invention, and associating said bonus prize with at least one game of each said electronic gaming machine.

The method preferably has the preferred features of the third aspect of the invention stated above, where applicable.

According to a seventh aspect of the invention, there is provided a computer system comprising a central processing unit configured for communication with an electronic gaming machine, wherein said computer system is configured to perform the method of the fourth, fifth or sixth aspects of the invention.

According to an eighth aspect of the invention, there is provided a computer program configured to perform the method of the fourth, fifth or sixth aspects of the invention.

According to a ninth aspect of the invention, there is provided a non-transitory carrier medium carrying computer executable code that, when executed on a central processing unit configured for communication with an electronic gaming machine, causes the central processing unit to perform the method of the fourth, fifth or sixth aspects of the invention.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to an embodiment of the invention;

FIG. 2 is a schematic drawing of an electronic game controller for the electronic gaming machine of FIG. 1, and

FIGS. 3 to 6 are simulated screen shots illustrating a game played on the electronic gaming machine of FIG. 1.

### DETAILED DESCRIPTION OF THE VARIOUS EMBODIMENTS

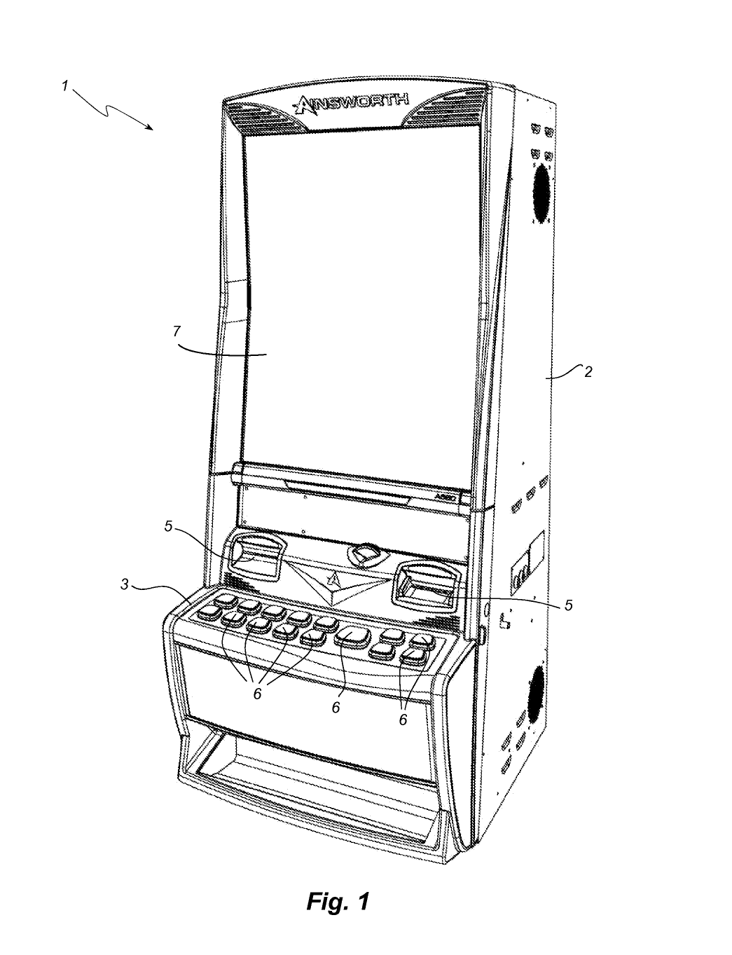

The present invention will now be described with reference to the following examples which should be considered in all respects as illustrative and non-restrictive. Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value.

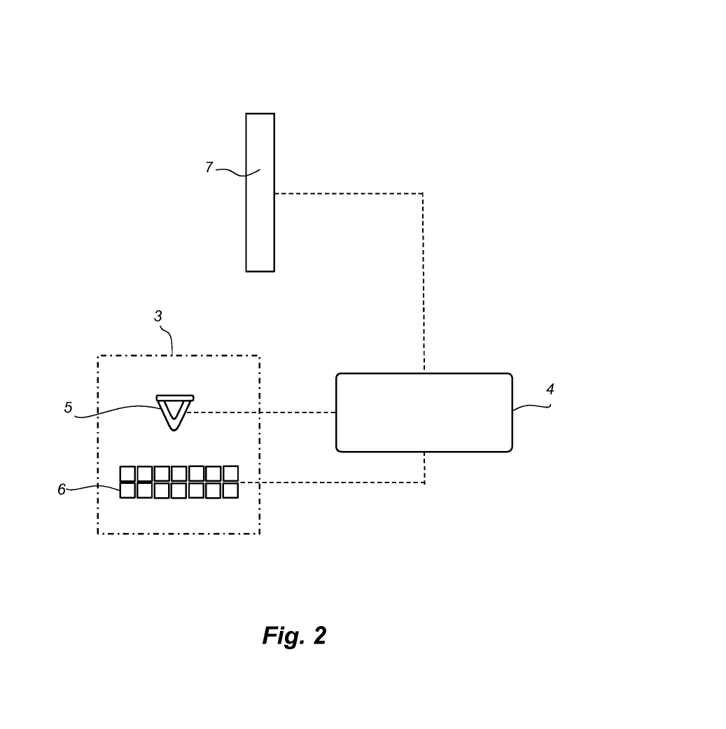

The electronic game controller 4 is generally in the form of a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store program instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the value received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value be added to the electronic gaming machine 1.

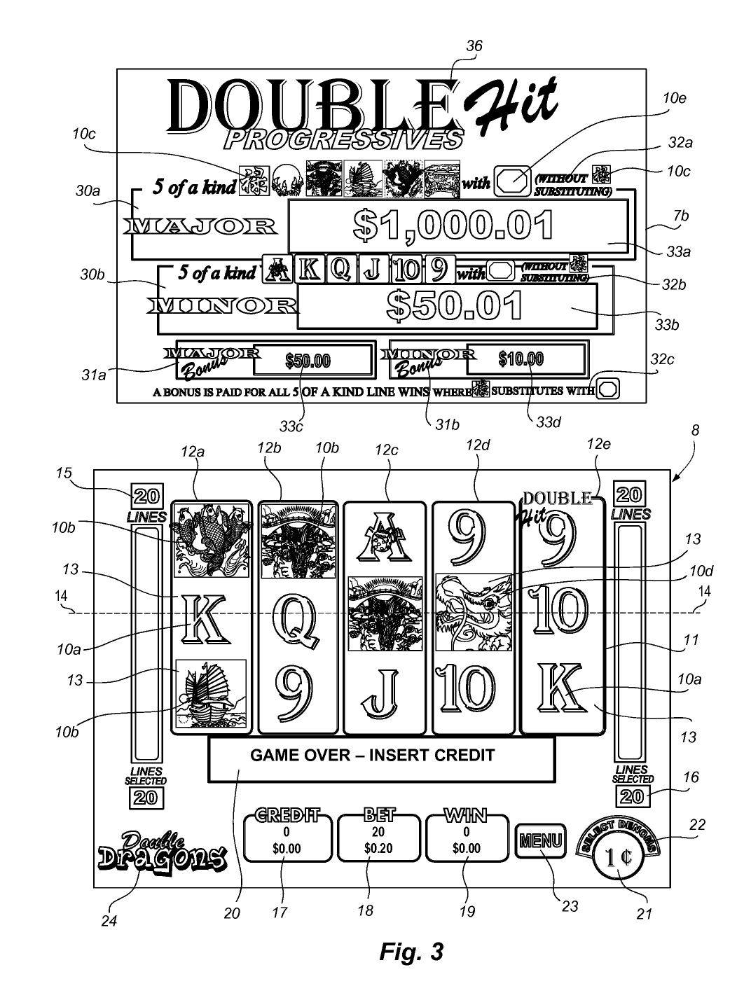

The electronic game controller 4 is programmed to provide a game in the form of a base game 8, as best shown in FIG. 3, and a feature game (not shown) on the video display screen 7 of the electronic gaming machine 1 for play by a player. The video display screen 7 is divided into a lower playing area 7a and an upper information display area 7b.

The base game 8 has game symbols 10 arranged into an array 11 in the form of five columns or “reels” 12 that are displayed in the lower playing area 7a, as best shown in FIG. 3. The reels 12 give the visual appearance of rotating, typically by having the game symbols 10 move in a downward linear path along the length of each reel 12. While the array 11 is arranged with five reels 12a, 12b, 12c, 12d, 12e and three rows, it will be appreciated by one skilled in the art that other types of arrays and array formats could be used, such as 3×3, 4×3, 5×5, 4×4, etc., including arrays having an irregular number of rows and/or columns. In other embodiments, the array 11 can have an unequal number or rows and/or columns, where some columns have less or more rows than other columns or where some rows have less or more columns than other rows. For example, the array 11 can have five reels of which two reels only have three rows while three reels have four rows. In some embodiments, the array 11 has an irregular shape. The electronic game controller 4 will transmit signals to the display screen 7 to cause the base game 8 and feature game 9 to be played on the display screen 7, including showing the game symbols 10, array 11, reels 12 and other visible elements of the base game and feature game, as discussed in more detail below

The array 11 of the base game 8 defines predetermined game positions symbol position or symbol positions 13, in which the game symbols 10 appear. The game or symbol positions 13 are not visually marked by boundary lines and simply provide an area for the game symbols 10 to appear. However, it will be appreciated that in other embodiments, the game or symbol positions 13 are defined by visible boundary lines (to define “squares” or symbol positions) or other markings to define each respective area of the symbol positions.

The array 11 is arranged so that a player can select one or more predetermined “pay lines” 14 defined around the array, which correspond to combinations of the game positions or symbol positions 13. The pay lines 14 correspond to the lines selectable by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

The game symbols 10 can include a mixture of picture symbols (such as animal symbols or playing card symbols), word symbols, scatter symbols, substitute or wild card symbols and trigger symbols to trigger the feature game 9. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. A trigger symbol is a symbol that triggers a game event or confers an award, where the trigger symbol may or may not have to appear in combination and may or may not have to appear on the same player-selected pay line 14. In this embodiment, the game symbols 10 include playing card symbols 10a, picture or item-themed symbols 10b, substitute or wild card symbols in the form of a Chinese character symbol 10c, a scatter symbol in the form of dragon symbol 10d and a trigger symbol in the form of an octagon symbol 10e. The electronic game controller 4 randomly determines and causes the appearance of the game symbols 10 on the array 11 in the symbol positions 13 of the reels 12.

The video screen 7 also displays other standard game information in the lower playing area 7a, including the number of pay lines available 15, the number of player-selected pay lines 16, the amount of player credits 17, the amount of the current bet wagered by the player 18, the amount of wins by the player 19, a message area 20, a denomination button 21 indicating the currently selected base bet denomination, message strip 22 associated with the denomination button 21, a menu button 23 for bringing up a menu screen (typically explaining the game rules and showing the available pay lines 14) and the name 24 of the game “Double Dragons” being played.

In the upper display area 7b, the video display screen 7 displays jackpot information about several bonus prizes (in the form of jackpots 30 and bonuses 31) associated with the base game 8 and/or electronic gaming machine 1, as best shown in FIG. 3. To avoid player confusion, where more than one game is provided by the electronic gaming machine 1, it is preferred that the same jackpots 30 are provided for each game. The jackpots 30 comprise a major jackpot 30a and a minor jackpot 30b. The bonuses 31 comprise a major bonus 31a and a minor bonus 31b. Text information strips 32a, 32b and 32c each explain the necessary conditions for winning each of the jackpots 30 and bonuses 31. Prize boxes 33a, 33b, 33c and 33d list the monetary amounts of the major jackpot 30a, minor jackpot 30b, major bonus 31a and minor bonus jackpot 31b, respectively. The theme for the game “Double Hit Progressives” is also indicated by a top banner 36.

In the base game 8, the player initially makes a bet using vending slots 5 to initiate play of the electronic gaming machine 1 by building up credit to play the base game on the electronic gaming machine. The player can bet or wager monetary amounts equivalent to a particular amount of credits, depending on the bet denomination selected for the base game. For example, the player can bet or wager 50 credits to play 10 pay lines or 200 credits to play 50 pay lines. Also, the player can make any additional side bets or ante-bets to access additional features in the base game 8, such as increasing the number of winning combinations in the game.

Typically, electronic gaming machines offer a number of preset bet options that the player can make, and these bet options can vary depending on the game or games offered on the electronic gaming machine 1. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc. The electronic gaming machine 1 also offers a variety of bet denominations of 1¢, 2¢, 5¢ and 10¢ for the base game 8.

The electronic game controller 4 then transmits a signal to the display 7 to cause the reels 12 to appear to visibly rotate or “spin” in a linear path, typically in a downward vertical direction, and randomly display the game symbols 10 in each symbol position 13 for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 10 can also be provided. If so, the gaming machine 1 enters a winning game state and awards a prize according to the displayed predetermined winning combination.

The electronic game controller 4 also determines whether one of the jackpots 30 or bonuses 31 have been won in the base game 8. In this embodiment, the jackpots 30 and bonus 31 are won where a specific combination of game symbols 10 appears in the player-selected pay lines 14, as outlined in the text strips 32a, 32b, and 32c. For example, as best shown in FIG. 3, the player will win the major jackpot 30a if there is a five of a kind of any of the picture symbol 10b and an octagon trigger symbol 10e in the player-selected pay lines 14, as noted in text strip 32a. Likewise, the minor jackpot 30b will be won by the player if there is a five of a kind of any of the playing card symbols 10a and an octagon trigger symbol 10e, as noted in text strip 32b.

In addition, the jackpots 30 are of higher value than the bonuses 31 as it is more difficult for the player to win one of the jackpots 30 compared to the bonuses 31. For example, the player will win the major bonus 31a instead of the major jackpot 30a if the five of a kind combination is composed of picture symbols 10b and at least one wild card or substitute Chinese character symbol 10c, together with an octagon trigger symbol 10e, as noted in text strip 32c. Similarly, the player will win the minor bonus 31b instead of the minor jackpot 30b if the five of a kind combination is composed of player card symbols 10a and at least one wild card or substitute Chinese character symbol 10c, together with an octagon trigger symbol 10e. This is because the major and minor jackpots 30a, 30b require “pure” combinations that do not rely on a substitute or wild card symbol 10c to achieve the five of a kind combination.

It will be noted that the octagon symbol 10e is a necessary condition for the player to win the jackpots 30 and bonuses 31. Hence, a player that achieves a five of a kind combination without the octagon symbol 10e will not “trigger” the jackpot 30 or bonus 31. While the octagon symbol 10e appears in the symbol positions 13 on the reels 13, in other preferred forms, a sixth reel is provided adjacent to the reels 12 that only shows the octagon symbol 10e or blank symbol positions 13 to act as a jackpot/bonus “trigger” reel.

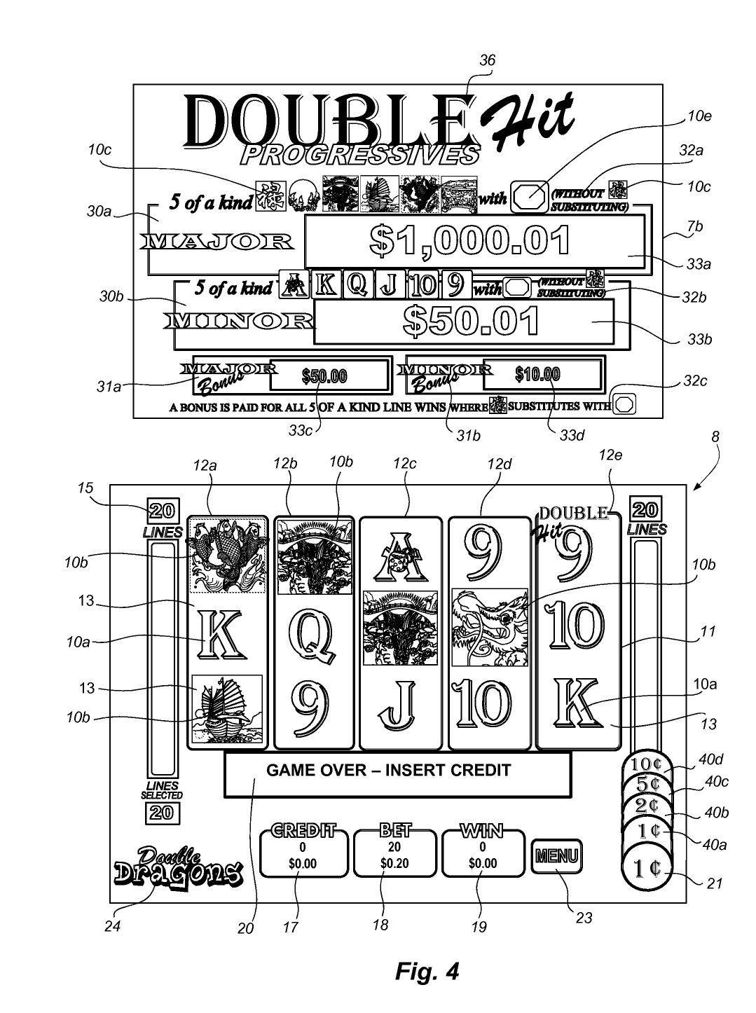

These jackpots 30 and bonuses 31 change in response to the selection of a bet level different to a default bet level. The bet levels in this embodiment are the base bet denominations of the base game 8, being 1¢, 2¢, 5¢ and 10¢ as respectively indicated by their associated bet denomination images 40a, 40b, 40c, 40d, as best shown in FIG. 4, where corresponding features have been given the same reference numerals.

Typically, the default bet level is the bet denomination that was previously used in the preceding play of the base game 8. For example, if a person had played the base game 8 with a bet denomination of 5¢, then this would be the default bet level for the player when he or she commences play of the game. Where the electronic gaming machine has not yet been played or has been started up, the default bet level is initially selected by the electronic game controller 4. The default bet level can be randomly selected or chosen according to a predetermined order. Usually, the electronic game controller 4 will select the bet denomination with the lowest value that is available for the base game 8, which would be the 1¢ bet denomination for this embodiment. The default bet denomination is shown on the denomination button 21 to indicate its current status. The player may change the bet denomination at any time in the base game 8 by touching the denomination button 21 before or after the reels 12 have spun.

Also, the default bet level is the bet denomination that is currently selected to play the game 8. In this case, the player may change the base bet denomination at any time in the base game 8 by touching the denomination button 21 during the game 8 but only before or after the reels 12 have spun. As best shown in FIG. 4, touching or selecting the denomination button 21 results in all the bet denomination images 40a, 40b, 40c, and 40d corresponding to their associated bet denominations appearing on the display 7 for selection by the player. This ensures that the player does not have to navigate through any menus or stop playing the game in order to change the base bet denomination. The player can then change the bet denomination by touching the desired denomination image, in response to which a confirmation pop-up message (not shown) appears over the array 11, as mandated by current regulatory requirements, requesting the player to confirm the change of the base bet denomination using “yes” and “no” buttons. If the player changes his or her mind, he or she may touch a “return to game” button (not shown) to continuing playing the base game 8. Alternatively, all the possible bet denomination images 40a, 40b, 40c, 40d can be shown continuously on the display screen 7 above the denomination button 21 during play of the base game 8.

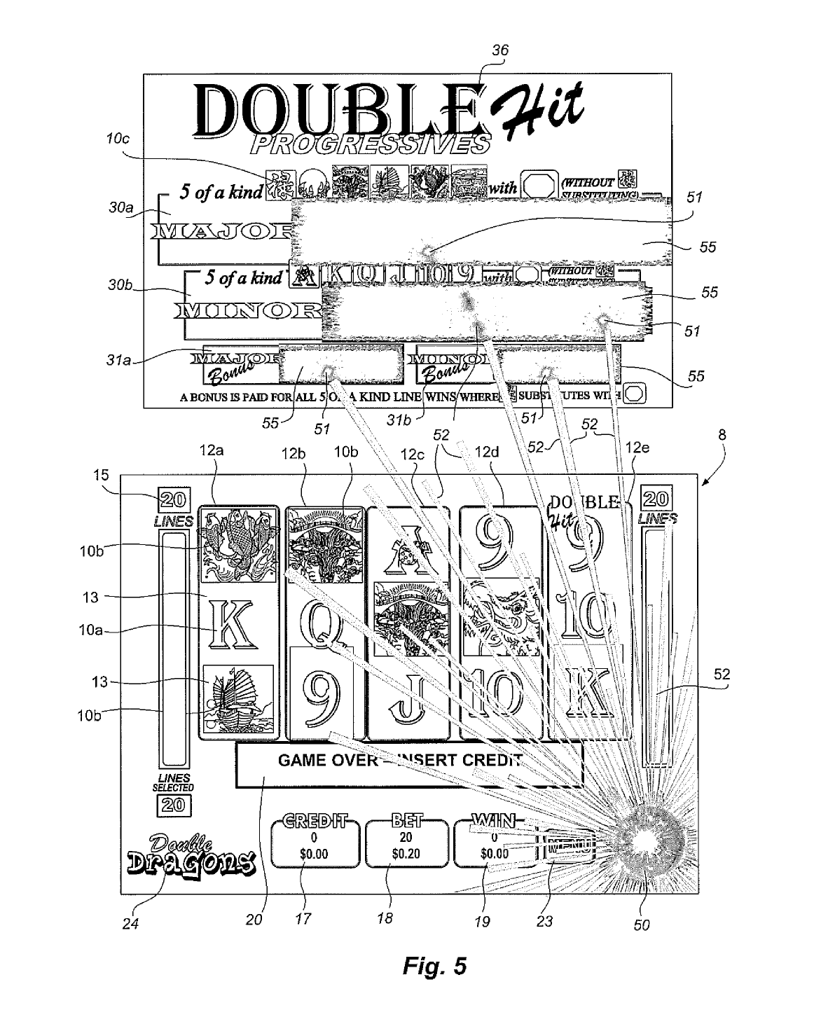

Referring now to FIG. 5, where corresponding features have been given the same reference numerals, the player has selected the bet denomination image 40b corresponding to bet denomination 2¢ to change from the current bet denomination of 1¢ that is displayed in the bet denomination button 21. The change in the selected bet denomination causes an animation to be played over the array 11, showing the bet denomination button 21 exploding into a bright ball 50 that sends out fireworks 51 leaving smoke trails 52 over the display screen 7 in both the lower playing area 7a and upper display area 7b. In addition, the fireworks 51 “hit” the prize boxes 33 of the jackpots 30 and bonuses 31, causing the prize boxes 33a, 33b, 33c, 33d to be lit or explode in a bright light 55 that obscures the monetary amounts originally in the prize boxes, as best shown in FIG. 5. This animation sequence is accompanied by suitable sounds and/or music to visually and aurally indicate the change in the bet denomination and the jackpots 30 and bonuses 31.

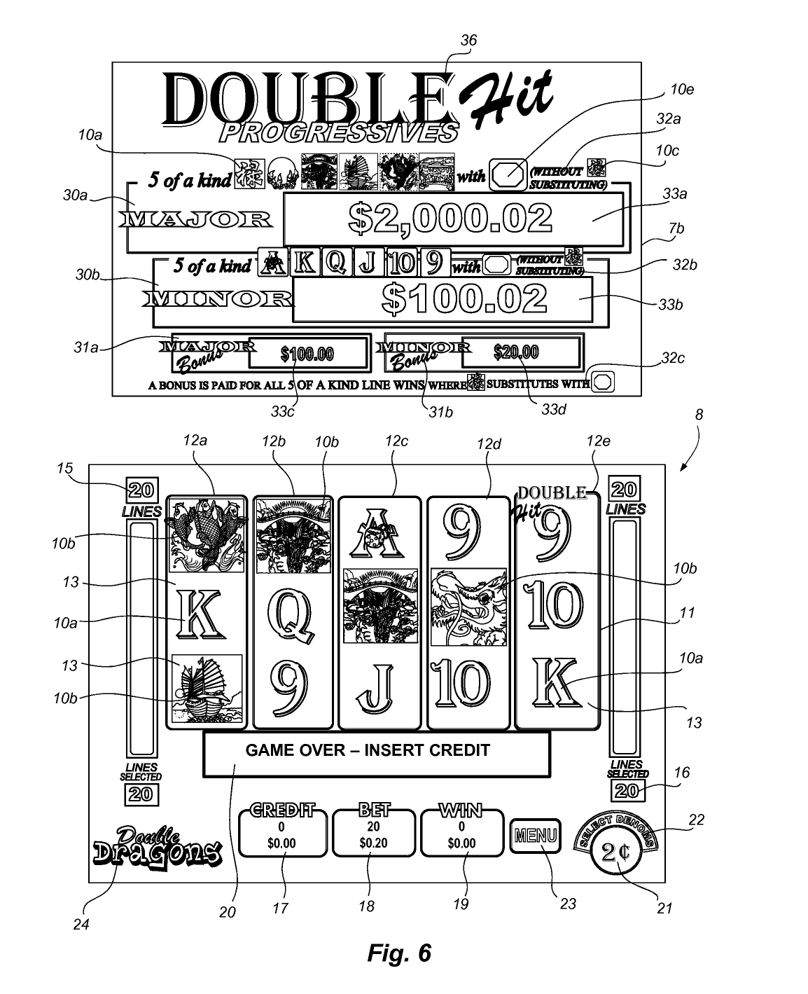

Moreover, this animation sequence visually links the selected bet denomination to the change in the values of the jackpots 30 and bonuses 31, via the exploding denomination button 21, the fireworks 51 hitting the prize boxes 33a, 33b, 33c, 33d, the prize boxes 33 being highlighted in bright lights 55 and the fireworks 51 leaving a visible smoke trail 52 that visually connects or links the denomination button 21 to the prize boxes 33a, 33b, 33c, 33d. Once the bright lights 55 fade from the prize boxes 33a, 33b, 33c and 33d and the animation ends, the monetary values for the jackpots 30a, 30b and bonuses 31a, 31b are revealed to have changed as a direct response to the change in the selected bet denomination, as best shown in FIG. 6, where corresponding features have been given the same reference numerals. Hence, once the bet denomination changes, there is a brilliant and striking display indicating the change in the jackpot and bonus values to the player, generating excitement and interest in the base game 8.

The bonus prize change can be indicated to the player in a number of ways other than described in relation to this embodiment. For example, the jackpots 30 and bonuses 31 and/or prize boxes 33 can be animated to indicate the bonus prize change, a bright light links the selected bet denomination image 40 to the jackpots 30 or bonuses 31 or their prize boxes or a separate indicator symbol or image can appear on the display 7 to direct the player's attention to the prize boxes 33 as they change. Other ways include changing colours, playing an animated or video sequence over the reels 12, with or without music and/or sound effects, and an aural announcement informing the player of the bonus prize change. It will be appreciated that other variations on the above described ways of indicating the bonus prize change are within the scope of the invention.

Referring to FIG. 6, the upper information display area 7b now shows the changes in the monetary amounts of the jackpots 30 and bonuses 31 due to the selection of a different bet denomination for the base game 8. In this embodiment, the monetary amounts for the jackpots 30 and bonuses 31 change depending on the ratio of the selected bet denomination to the previous bet denomination. In this example, the initial bet denomination was 1¢ and the selected bet denomination is 2¢. Hence, ratio of the selected bet denomination to the previous bet denomination is 2:1, and thus the monetary amounts in the prize boxes 33a, 33b, 33c, 33d are respectively doubled in accordance with this ratio. Thus, the major jackpot 30a increases from $1,000.01 to $2,000.02, the minor jackpot 30b increases from $500.01 to $1,000.02, the major bonus 31a increases from $50 to $100 and the minor bonus 31b increases from $10 to $20.

It will be appreciated that this ratio also results in a reduction in the monetary amounts in the prize boxes 33a, 33b, 33c, 33d for the jackpots 30 and bonuses 31 where the bet denomination reduces in value. For example, if the player subsequently changes the bet denomination back from 2¢ to 1¢, the monetary amounts in the prize boxes 33a, 33b, 33c, 33d for the jackpots 30 and bonuses 31 would be halved as the ratio is now 1:2. This change in the monetary values of the jackpots 30 and bonuses 31 equally applies to the other bet denominations of 5¢ and 10¢. For example, changing the bet denomination from 2¢ to 10¢ would result in a ratio of 10:2 or 5:1, multiplying the monetary amounts in the prize boxes 33a, 33b, 33c, 33d by 5. Thus, the major jackpot 30a increases from $2,000.02 to $10,000.10, the minor jackpot 30b increases from $1,000.02 to $5,000.10, the major bonus 31a increases from $100 to $500 and the minor bonus 31b increases from $20 to $100.

Also, it will be appreciated that the monetary amounts in the prize boxes 33a, 33b, 33c, 33d for the jackpots 30 and bonuses 31 are not static but are dynamic in nature. In this embodiment, the jackpots 30 and bonuses 31 are progressive jackpot prizes in that as the base game 8 is played on the electronic gaming machine 1, a portion of each bet is taken and added to each jackpot 30 and bonus 31 to gradually increase the monetary amount displayed in each respective prize box 33a, 33b, 33c, 33d until the jackpot 30 or bonus 31 is won. Then the jackpot or bonus is reset to a base monetary value from which it again increases incrementally as bets are made on the electronic gaming machine 1. In other embodiments, the jackpots 30 and bonuses 31 are not progressive but increase by a fixed amount after a predetermined amount of playing time has passed.

The ratio effect on the jackpots 30 and bonuses 31 depending on the selection of the bet denomination is illustrated in more detail in Table 1 below, using exemplary bet denominations and exemplary amounts for the bonus prize.

TABLE 1

| | | Ratio relative to | Ratio relative to |
|---|---|---|---|
| Bet | Bonus prize | lowest bet | highest bet |
| denomination | value | denomination value | denomination value |
| $1 | $1,000 | 100:1 | — |
| 50¢ | $500 | 50:1 | 1:2 |
| 20¢ | $200 | 20:1 | 1:5 |
| 10¢ | $100 | 10:1 | 1:10 |
| 5¢ | $50 | 5:1 | 1:20 |
| 2¢ | $20 | 2:1 | 1:50 |
| 1¢ | $10 | — | 1:100 |

Table 1 includes the ratios between the bet denominations relative to the bet denominations with the lowest and highest values for illustrative purposes. However, it will be appreciated that the bet denominations selected by the player can be between intermediate bet denominations of intermediate values. For example, if a player changes from a 5¢ bet denomination to a 20¢ bet denomination the ratio is 4:1, resulting in the jackpots 30 and bonuses 31 being increased by a factor of 4 (i.e. multiplied by 4). Conversely, if a player changes from a 50¢ bet denomination to a 20¢ bet denomination, the ratio is 2:5, resulting in the jackpots 30 and bonuses 31 being reduced by 40%.

As demonstrated by the preferred embodiment of the invention, the change in the values of the jackpots 30 and bonuses 31 when the player changes the bet denomination is strikingly indicated to the player, providing a direct correlation to the player between the selected bet denomination and the amount of the jackpots 30 and bonuses 31 (especially where there is a large ratio between the selected bet denomination and the previous bet denomination, creating a multiplier effect that significantly increases the values of the jackpots 30 and bonuses 31). It also enhances player excitement and interest in the electronic gaming machine 1, thus encouraging the player to keep playing the electronic gaming machine.

In other embodiments, the change in the bonus prizes (being the jackpots 30 and bonuses 31) need not be the ratio of the selected bet level to the default bet level, but can be based on other relationships other than a linear increase or decrease in the bonus prize values that occur using a ratio. One type of relationship is to provide a non-linear change in the bonus prize values as the selected bet denomination changes. This can be achieved by unrelated changes in the bonus prize value between selected bet levels (or bet denominations). For example, the bet denominations are associated with a fixed bonus prize value, so that a change to a particular bet denomination results in the bonus prize values changing to the fixed value associated with the bet denomination. In another example, a fixed value is added to the current monetary value of the bonus prize depending on the selected bet level. In this instance, changing to a lower bet denomination would change the amount of the added component to the bonus prize value. Other examples include separating the bonus prize values associated with the bet denominations by a fixed amount or using a non-linear increase or decrease in the bonus prize value as the bet denomination is increased or decreased, respectively.

These different changes to the bonus prize value relative to the selected bet level is shown in more detail in Table 2 below using exemplary bet denominations and exemplary amounts. These bonus prize value changes can be used for both fixed and progressive bonus prizes.

TABLE 2

| | Bonus prize change | | | |
|---|---|---|---|---|
| | | | | (d) |
| | | (b) | | Bonus prize |
| Bet | (a) | Fixed bonus | (c) | values |
| level | Non-linear | prize values | Bonus prize | increase by |
| (bet | change in | added to the | values differ | increments |
| denom- | bonus prize | current bonus | by a fixed | that double |
| ination) | values | prize value | amount of $25 | each bet level |
| $1 | $1,500 | +$500 | $175 | $1,585 |
| 50¢ | $1,000 | +$400 | $150 | $785 |
| 20¢ | $800 | +$300 | $125 | $385 |
| 10¢ | $500 | +$150 | $100 | $185 |
| 5¢ | $350 | +$75 | $75 | $85 |
| 2¢ | $200 | +$25 | $50 | $35 |
| 1¢ | $10 | +$10 | $25 | $10 |

In a further embodiment, the bonus prize itself may change from a monetary amount to a game enhancing element, such as free games, a multiplier of wins, making one or more reels 12 show only wild card symbols 10c, etc., depending on the selected bet denomination.

The invention is also applicable to other types of bet levels. In one embodiment, the bet levels are the amounts bet per pay line 14 for the base game 8 instead of the bet denomination. In this embodiment, the player is able to select from a range of preset bet options, such as 1 credit per pay line, 3 credits per pay line and 5 credits per pay line. Depending on the selected bet option, the monetary values of the jackpot 30 and bonus 31 are increased or decreased relative to the previous bet option in the same way as described above in relation to the selection of bet denominations.

An example of this application of the invention using credits bet per line as the bet levels is shown in Table 3 below, using exemplary bet denominations and exemplary amounts. Again, these bonus prize value changes can be used for both fixed and progressive bonus prizes.

TABLE 3

| | Bonus prize change | | |
|---|---|---|---|
| | | | Bonus prize |
| | | | values increase |
| Bet level | Linear change | Non-linear change | by increments |
| (credits bet | in bonus prize | in bonus prize | that double each |
| per pay line) | values (ratio) | value | bet level |
| 10 credits | $1,000 | $900 | $1,575 |
| per pay line | | | |
| 5 credits | $500 | $750 | $775 |
| per pay line | | | |
| 3 credits | $300 | $500 | $375 |
| per pay line | | | |
| 2 credits | $200 | $200 | $175 |
| per pay line | | | |
| 1 credit | $100 | $50 | $25 |
| per pay line | | | |

In other preferred forms, only a portion of the bonus prize value changes in response to the selected bet level. For example, a progressive jackpot may have incremented to a value of $257.45 and the player changes the bet denomination from 1¢ to 5¢. In this case, only a specified portion, say the nearest hundred (being $200), is multiplied by the ratio of 5:1 to increase the jackpot to $1,057.45. Alternatively, the specified portion that is multiplied by the 5:1 ratio is equal to the start-up value of the progressive jackpot. In this alternative case, if the progressive jackpot started with a value of $250 and incremented during normal play to $257.45 before the player changed the bet level from 1¢ to 5¢, then the jackpot level would be increased $1,257.45, being the current incremental amount of $7.45+the multiplied start-up value of $1,250 (i.e. $250×5). This change to a portion of the bonus prize can be applied to any of the bonus prize changes discussed above.

In the embodiment, the feature game is triggered by the appearance of three dragon symbols 10d in any of the symbol positions 13 of the reels 12 on the player-selected pay lines 14. In response to the feature game trigger event of three dragon symbols 10d, the electronic game controller 4 causes the feature game to appear on the video screen 7. The feature game also uses the same game symbols 10 as the base game, as well as the same array 11, reels 12, symbol positions 13 and player-selectable pay lines 14 on the video screen 7.

The change to the feature game removes the jackpots 30 and bonuses 31 from play and replaces them with other bonus prizes, since there is usually no opportunity to change the bet denomination during the feature game. However, it will be appreciated that in other embodiments, the jackpots 30 and bonuses 31 are retained for the feature game and can be changed as described above in response to the selection of a different bet denomination to the current bet denomination being used. Of course, this means that the player is able to change the bet denomination during play of the feature game. In a further preferred form, a portion of the jackpot 30 and/or bonus 31 is used in the feature game and added to the remainder upon the electronic gaming machine 1 returning to the base game 8. In other preferred forms, the invention is applied only to a feature game. In this case, the invention would work in the same way as described in relation to the base game 8.

In the feature game, a predetermined number of free plays or spins of the feature game are awarded to the player. That is, the reels 12 in the feature game are spun without requiring the player to make a bet, unlike the base game. In addition, the number of free spins can be indicated in a counter (not shown) on the lower playing area 7a. It will be understood by those skilled in the art that these free plays or spins are commonly referred to as “free games”. The feature game would operate in a similar manner to the base game 8, where the reels 12 visibly rotate and display randomly selected game symbols 10 in each symbol position 13. Predetermined winning combinations of randomly selected game symbols 10 in the reels 12 of the feature game would also result in the award of prizes to the player, usually of an enhanced value compared to the prizes awarded in the base game. This would also extend to the jackpots 30 and bonuses 31 where they are retained for the feature game.

While the preferred embodiment has been described in relation to fixed and progressive jackpot-type bonus prizes in relation to a single electronic gaming machine 1, it will be appreciated that the invention is applicable to multiple electronic gaming machines linked together as a gaming system. For example, the jackpots 30 and/or bonuses can be progressive bonus prizes that are configured to be part of a wide area or in-house link progressive jackpot. In other words, the progressive jackpot can be awarded on a group of networked gaming machines in a specified area or a group of specified electronic gaming machines that are linked together for jackpot purposes. In this case, there is a central jackpot or bonus prize controller that is in electronic communication with the electronic game controllers 4 of each linked electronic gaming machine 1 that monitors and controls the award of the jackpots 30 and bonuses 31. However, the individual electronic game controllers 4 would each control the changes to the bonus prizes in response to the selected bet level and communicate these changes to the central bonus prize controller.

Also, the invention is applicable to electronic gaming machines that provide a plurality of games, so-called multi-game gaming machines. In this instance, there can be one or more bonus prizes associated with each game that change in response to the change in the selected bet level or a plurality of bonus prizes where only one or some are changed in response to the change in the selected bet level. Also, one or more of the bonus prizes can be shared by two or more games. This can also apply where there is a plurality of electronic gaming machines linked together as described above. That is, one or more bonus prizes across several or all the linked electronic gaming machines change in response to a change in the selected bet level, and this may occur for only one, some or all of the games offered on each electronic gaming machine.

It will be appreciated that the invention also includes other types of changes to the prize value change and the numerical value associated with the selected bet level. One type of change in the prize value is achieved by replacing or supplementing one of the digits of the prize value. For example, a numerical value of 3 is associated with a selected bet level (perhaps due to a ratio of 3:1), and a bonus prize value of, say, $250 could be changed by adding the number 3 into the bonus prize value number to create altered prize values of $2,503, $2,530, $2,350 and $3,250. Using the same example, the number 3 could replace the one of the digits to create a changed bonus prize value of $350.

While the same game format can be essentially used across the base game and feature game, it will be appreciated that the game format may vary across both the base game and feature game. For example, the feature game could adopt a different format of symbol positions and/or use an entirely different set of game symbols, or a mixture of game symbols from the base game and different game symbols. In another example, the base game may be a wheel-type game or a four reel game and the feature game may be a standard five reel game. Similarly, the base game and feature game may each have different game symbols, game rules and pay tables that are unique to each game. Also, the arrangement of the base game 8 and the feature game is not limited to a set of reels or columns, but could take other forms, such as non-rectangular arrays (i.e. arrays that do not comprise rows and columns). For example, where the array is circular, the predetermined game positions can take the form of pie-shaped slices or wedges.

In another preferred form, there is no need for a trigger event in the form of the appearance of a predetermined number of trigger symbols, such as the scatter symbols 10d. Instead, the electronic game controller 4 can internally determine when to trigger the feature game in the base game. One way to implement this preferred form is for the electronic game controller 4 to internally generate a random number and checks if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur in the base game and activating the feature game. This random number generation can also be used by the electronic game controller 4 to determine whether the player has won one of the bonus prizes (jackpots 30 or bonuses 31) in the base game 8. This type of trigger for the bonus prize is commonly referred to as a mystery jackpot. That is, none of the symbols in the game trigger the jackpot; hence the triggering event is a “mystery”.

While one embodiment of the invention has been described in relation to a base game and a feature game, it will be appreciated that the invention could include one or more additional feature games that are triggered by specific trigger symbols appearing in the feature game. Also, the additional feature games may also have trigger symbols that trigger further feature games in a cascading fashion. These additional and further feature games could have the same game play elements as the feature game or be different feature games entirely.

Furthermore, the embodiments of the invention have been described as providing a standard 5×3 set of reels 12 for the base game 8. However, it will be appreciated that in other embodiments, the size and shape of the reels 12. For example, the array 11 could take any number of different shapes, such as triangular, circular, square, hexagonal, hemi-spherical or other polygonal shapes. Alternatively, the arrays 11 could have an uneven number of rows and/or columns. For example, the reels 12a, 12b could have three rows, but the reels 12c to 12e could have four rows.

Also, in a further preferred form, the player can selectively stop spinning of the reels 12 to increase player interaction and provide the player with an opportunity to guess when a desirable game symbol may appear in a symbol position 13. Furthermore, the player can start spinning of the reels 12 to further enhance player interaction.

In other preferred forms, the base game 8 (and the feature game) need not be displayed on a single video screen 7. Instead, they may be displayed on separate video screens, with the lower playing area 7a appearing in a lower video screen and the information display area 7b on an upper video screen. Also, the order can be reversed, with the playing area 7a appearing on an upper video screen or upper part of a single video display screen 7 and the information display area 7b appearing on a lower video screen or lower part of a single video display screen.

In another preferred form, the video screen 7 is a touch screen for use in addition to the player-actuatable buttons 5 so as to enable the player to select the bet level (such as bet denominations or bet per pay line 14) as well as other various features, such as making monetary bets for the game, initiating play of any base and feature games played and responding to any messages or requests issued on the electronic gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10 may appear in the reels 12.

In other preferred forms, the bonus prizes are shared with any other games offered on the electronic gaming machine (as in multi-game gaming machines). In another preferred form, only one of the bonus prizes changes in response to the selected bet level to further emphasise that particular bonus prize. This can be extended to electronic gaming machines linked together

Also, the bonus prize can be won other than achieving a particular combination of game symbols 10 as described in relation to FIGS. 3 to 6. Instead, specific bonus prize symbols could be used that must appear anywhere on the player-selected pay lines 14 or on the same pay line 14 to win the bonus prize.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer program configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of the player being able to selectively starting or stopping spinning of the reels 12 and the feature of providing a non-linear change in the bonus prize values can be combined into a single electronic gaming machine. Similar combinations of two or more features from the above described embodiments or preferred forms of the invention can be readily made by one skilled in the art.

By providing the player with the ability to vary the bonus prize associated with a game being played based on a selected bet level, the invention introduces a variety in game play and game mechanics to the player, thus increasing the player's excitement and retaining his or her interest in playing the same electronic gaming machine. Also, by further indicating the bonus prize change, the invention in its preferred embodiments further increases the player's interest and participation in the electronic gaming machine as the player sees a direct connection between the selected bet level and the change in the bonus prize. The invention also adds greater value to the player in terms of providing a greater reward to increasing the bet level as the amount of the bonus prize also increases, compared to a conventional electronic gaming machine. All these advantages of the invention result in the player being more likely to retain interest in continuing to play the same electronic gaming machine due to the variation in the game play on the electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a housing having a display for displaying a game and an electronic game controller for controlling the display of game symbols on said display, wherein said game comprises game symbols arranged into an array of symbol positions and predetermined winning combinations of randomly selected game symbols that award prizes to a player, wherein there is a plurality of bet levels for said game, said bet levels comprising at least a default bet level; and
an input means for receiving commands from said player to operate said electronic gaming machine and initiate play of said game on said display, said input means being in electronic communication with said electronic game controller;
said electronic game controller in response to a command from said player via said input means commences play of said game by randomly selecting game symbols and transmitting a signal to said display to display said randomly selected game symbols in said symbol positions on said array;
wherein said electronic game controller enables selection of one of said bet levels, and
in response to a selected bet level different to said default bet level, said electronic game controller changes a bonus prize associated with said game.

2. The electronic gaming machine of claim 1, wherein said electronic game controller indicates said bonus prize change on said display.

3. The electronic gaming machine of claim 1, wherein said bonus prize change is visually displayed on said display.

4. The electronic gaming machine of claim 2, wherein said bonus prize change is indicated on said display by one or more of animating a bonus prize image associated with said bonus prize, highlighting said bonus prize image on said display, changing said bonus prize image, displaying one or more animated images, visually linking said bonus prize change to said selected bet level and playing one or more aural sounds.

5. The electronic gaming machine of claim 1, wherein said bonus prize change comprises changing the value of said bonus prize in response to said selected bet level.

6. The electronic gaming machine of claim 5, wherein said bonus prize changes in value based on a numerical value associated with said selected bet level.

7. The electronic gaming machine of claim 6, wherein said numerical value is the ratio of said selected bet level to said default bet level and the value of said bonus prize changes by said ratio.

8. The electronic gaming machine of claim 6, wherein said numerical value is a base prize bonus value and the value of said bonus prize changes by said base prize bonus value multiplied by the number of bet levels between said selected bet level and said default bet level.

9. The electronic gaming machine of claim 5, wherein said bet levels are respectively associated with different bonus prize values and said bonus prize changes to the bonus prize value associated with said selected bet level.

10. The electronic gaming machine of claim 5, wherein a portion of said bonus prize changes in value and the remainder of said bonus prize does not change.

11. The electronic gaming machine of claim 10, wherein said bonus prize portion changes in value based on a numerical value associated with said selected bet level.

12. The electronic gaming machine of claim 11, wherein said numerical value is the ratio of said selected bet level to said default bet level and the value of said bonus prize portion changes by said ratio.

13. The electronic gaming machine of claim 11, wherein said numerical value is a base prize bonus value and the value of said bonus prize portion changes by said base prize bonus value multiplied by the number of bet levels between said selected bet level and said default bet level.

14. The electronic gaming machine of claim 10, wherein said bet levels are respectively associated with different bonus prize portion values and said bonus prize portion changes to the bonus prize portion value associated with said selected bet level.

15. The electronic gaming machine of claim 1, wherein said selected bet level is selected by said player during play of said game.

16. The electronic gaming machine of claim 1, wherein said selected bet level is selected by said player prior to playing said game.

17. The electronic gaming machine of claim 1, wherein said bonus prize has an initial bonus prize value associated with said default bet level.

18. The electronic gaming machine of claim 1, wherein said default bet level is one of said bet levels previously selected on said electronic gaming machine.

19. The electronic gaming machine of claim 1, wherein said default bet level is one of said bet levels that is currently selected to play said game.

20. The electronic gaming machine of claim 1, wherein said default bet level is one of said bet levels initially selected by said electronic game controller.

21. The electronic gaming machine of claim 20, wherein said electronic game controller selects the bet level with the lowest value of said bet levels as said default bet level.

22. The electronic gaming machine of claim 1, wherein said bet levels comprise bet denominations for said game.

23. The electronic gaming machine of claim 22, wherein each change in said bet denomination causes said bonus prize change.

24. The electronic gaming machine of claim 1, wherein said game comprises said randomly selected game symbols displayed in an array of predetermined game positions, and said bet levels are associated with one or more combinations of said predetermined game positions.

25. The electronic gaming machine of claim 24, wherein said bet levels comprise bet amounts for each said combination.

26. The electronic gaming machine of claim 1, wherein said electronic gaming machine provides a plurality of said games, said games being linked to said bonus prize.

27. The electronic gaming machine of claim 1, wherein said electronic gaming machine provides a plurality of said games and a plurality of said bonus prizes, and at least one of said bonus prizes is shared by two or more of said games.

28. The electronic gaming machine of claim 27, wherein all of said bonus prizes are shared by two or more of said games.

29. The electronic gaming machine of claim 1, wherein said bonus prize is one of a jackpot prize, a progressive jackpot prize or a mystery bonus prize.

30. The electronic gaming machine of claim 1, wherein said housing comprises a value transfer mechanism for paying said prizes to said player using value in an amount equal to an awarded prize.

31. A gaming system comprising a plurality of electronic gaming machines of claim 1, wherein said electronic gaming machines are in electronic communication with each other and said bonus prize is associated with at least one game of each said electronic gaming machine.
